(19) United States
(12) Patent Application Publication
(10) Pub. No.: US 2013/0004012 A1
(43) Pub. Date: Jan. 3, 2013

(54) Electronic tablet device's sound guide cover

(76) Inventor: Pei-Lin HUANG, New Taipei City (TW)

(21) Appl. No.: 13/534,147

(22) Filed: Jun. 27, 2012

(30) Foreign Application Priority Data
Jul. 1, 2011 (TW) 100212060

(51) Int. Cl. H04R 1/02

(52) U.S. Cl. 381/388

(57) ABSTRACT

An electronic tablet device's sound guide cover comprises a shield and a sound guide member: the shield is a tabular member with some fastener devices at the shield's corners and relies on the fastener devices to clasp the electronic tablet device and adhere to the electronic tablet device's external cover; the sound guide member on the shield corresponds to the electronic tablet device's speaker; the sound guide member and the speaker form a gap in between; the sound guide member and the electronic tablet device's external cover form a sound guide channel in between; the sound guide channel has a sound outlet facing the electronic tablet device's front and guiding audio or sound out of the electronic tablet device to a user.

### BACKGROUND OF THE INVENTION

The current application claims a foreign priority to the patent application of Taiwan No. 100212060 filed on Jul. 1, 2011.

### FIELD OF THE INVENTION

The present invention relates to a protective cover for an electronic tablet device, particularly a sound guide cover which guides audio or sound out of an electronic tablet device to a user.

### DESCRIPTION OF THE PRIOR ART

The fast-developed electronic and IT industry has led to more and more constantly innovative 3C products wherein tablet computers much in demand in the market have been replacing notebook computers and becoming one of the most popular 3C products. In order to prevent a tablet computer from drop or collision-induced damage, a lot of anti-bumping or scratch-resistant protective covers for tablet computers have been developed and available in the market because a tablet computer different from existing notebook or desktop computers is usually held by one or two hands, for instance, the disclosed R.O.C. Patent M390689, “Improved Protective Cover”, and the disclosed R.O.C. Patent M396421, “Protective Frame Structure for Tablet Computers”, are categorized to these products.

With a touch panel installed at the front, an electronic tablet device is provided with speakers on the electronic tablet device's rear cover or side cover only so that the electronic tablet device's normal sound effect may be seriously affected in the event of a protective cover on the electronic tablet device not properly designed and hindering speakers. For example, the protective covers in the disclosed R.O.C. Patent M390689, “Improved Protective Cover”, and the disclosed R.O.C. Patent M401335, “Protective Cover for Telecommunication Products”, are not properly deigned to circumvent speakers. In general, an opening on an electronic tablet device's protective cover should correspond to a speaker, so as not to obstruct sound out of the speaker, for instance, the R.O.C. Patent M396421, “Protective Frame Structure for Tablet Computers”. In practice, the abovementioned speakers do not face a user who is operating and staring at the electronic tablet device and makes the user hear weak and scattered sound or turn up volume for clear sound. This inferior design adversely affects not only an electronic tablet device's audio quality but also power consumption.

### SUMMARY OF THE INVENTION

The present invention provides an electronic tablet device's sound guide cover which is used in preventing the electronic tablet device's external cover from incidental collision-induced damage and further guiding audio or sound out of the electronic tablet device to a user.

The present invention in one embodiment comprises:

A shield as a tabular member provided with some fastener devices wherein the fastener devices erect at the shield's corners and clasp the electronic tablet device so that the shield adheres to an external cover of the electronic tablet device;

A sound guide member disposed at the shield and corresponding to the electronic tablet device's speaker: the sound guide member and the speaker form a gap in between; the sound guide member and the external of the electronic tablet device form a sound guide channel in between; the sound guide channel has a sound outlet facing the electronic tablet device's front and guiding audio or sound out of the electronic tablet device to a user.

In one embodiment of the present invention, the sound guide member and the shield are developed to be a one-piece structure.

In another embodiment of the present invention, the sound guide member is assembled to or separated from the shield.

In a further embodiment of the present invention, the sound guide member guides sound out of the speaker at the electronic tablet device's side cover to a user and is provided with a first reflector which corresponds to the speaker for development of a gap between the first reflector and the speaker and reflects sound out of the speaker to a user.

In yet another embodiment of the present invention, the sound guide member guides sound out of the speaker at the electronic tablet device's rear cover to a user and is provided with a first reflector and a second reflector: the second reflector corresponds to the speaker; the second reflector and the speaker form a gap in between; the second reflector reflects sound out of the speaker to the first reflector which further reflects the sound from the second reflector to a user.

It can be seen from the above descriptions that the present invention of an electronic tablet device's sound guide cover which relies on the sound guide member can guide audio or sound out of the electronic tablet device to a user and favorably promote audio quality of the electronic tablet device.

The advantages, effects and embodiments in terms of the present invention are further interpreted in detailed descriptions and drawings as follows.

### BRIEF DESCRIPTIONS OF THE DRAWINGS

FIG. 1 illustrates a structure of the present invention in one embodiment and is a perspective view of the electronic tablet device's sound guide cover.

FIG. 2 is a partial enlargement view of FIG. 1 and illustrates details of the sound guide member.

FIG. 3 illustrates a structure of the present invention in one embodiment and a cross-section of the sound guide member with the sound guide cover installed on the electronic tablet device.

FIG. 4 illustrates a cross-section of the sound guide member with the sound guide cover installed on the electronic tablet device.

FIG. 5 illustrates a structure of the sound guide member in another embodiment and a cross-section of the second reflector.

FIG. 6 illustrates a structure of the sound guide member in a further embodiment and another cross-section of the second reflector.

FIG. 7 illustrates a structure of the sound guide member in yet another embodiment and a cross-section of the first reflector and the second reflector.

FIG. 8 illustrates a structure of the present invention in another embodiment for two speakers at the rear cover of the electronic tablet device.

FIG. 9 illustrates a structure of the present invention in a further embodiment for two speakers at the side cover of the electronic tablet device.

FIG. 10 illustrates a structure of the sound guide member in yet a further embodiment and a cross-section of the first reflector and the speaker at the side cover of the electronic tablet device.

FIG. 11 illustrates a structure of the present invention in yet a further embodiment for the sound guide member separated from the shield.

FIG. 12 is a partial enlargement view of FIG. 11 and illustrates details of the sound guide member.

### DETAILED DESCRIPTIONS OF THE PREFERRED EMBODIMENTS

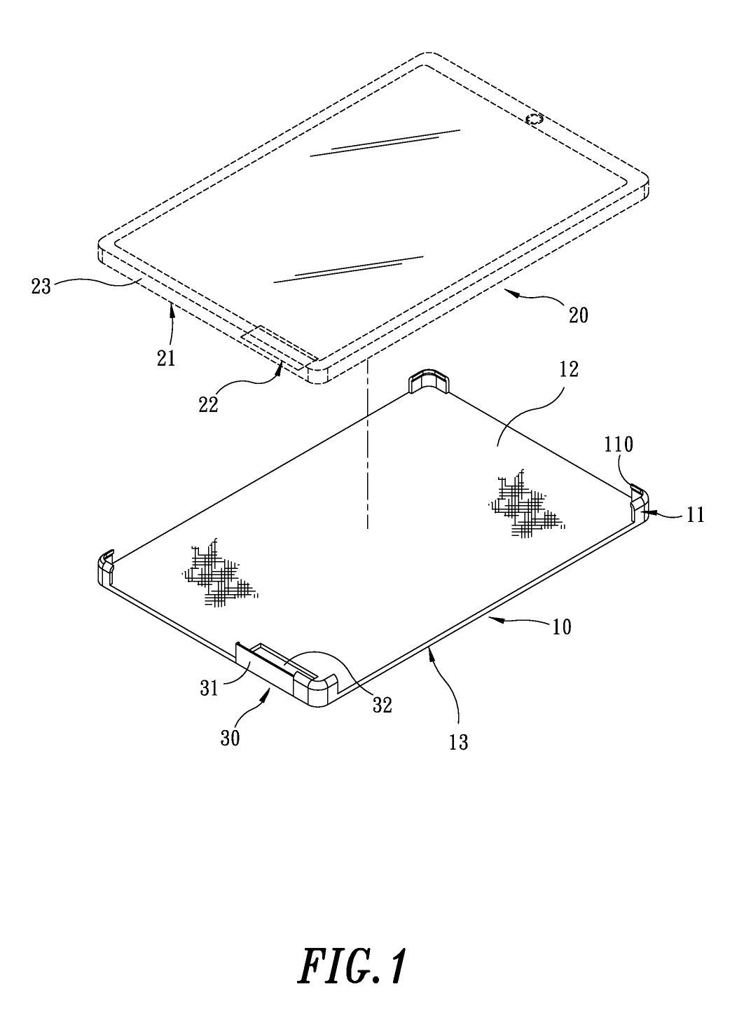

As shown in FIG. 1, an electronic tablet device's sound guide cover in one embodiment comprises:

A shield 10 which is a tabular component and provided with some fastener devices 11 at corners wherein each of the fastener devices 11 has a hook part 110 at the top slightly bending toward the center of the shield 10, so as to clasp the corners of the electronic tablet device 20, which is accommodated in the shield 10, and makes the shield 10 adhere to an external case 21 of the electronic tablet device 20;

A sound guide member 30 which is disposed at the shield 10 and aligns a speaker 22 of the electronic tablet device 20: a gap G1 exists between the sound guide member 30 and the speaker 22 (FIG. 3) for development of a sound guide channel 40 between the sound guide member 30 and the external case of the electronic tablet device 20 wherein the sound guide channel 40 has a sound outlet 41 facing the front of the electronic tablet device 20 for guiding audio or sound out of the electronic tablet device 20 to a user.

In one embodiment (FIG. 3), the sound guide member 30 which guides sound from the speaker 22 at a rear cover 21 of the electronic tablet device 20 to a user comprises a first reflector 31, a second reflector 32 and a side wall 33 wherein the second reflector 32 and its corresponding speaker 22 forms a gap in between and the second reflector 32 reflects sound out of the speaker 22 to the first reflector 31 which further reflects sound from second reflector 32 to a user.

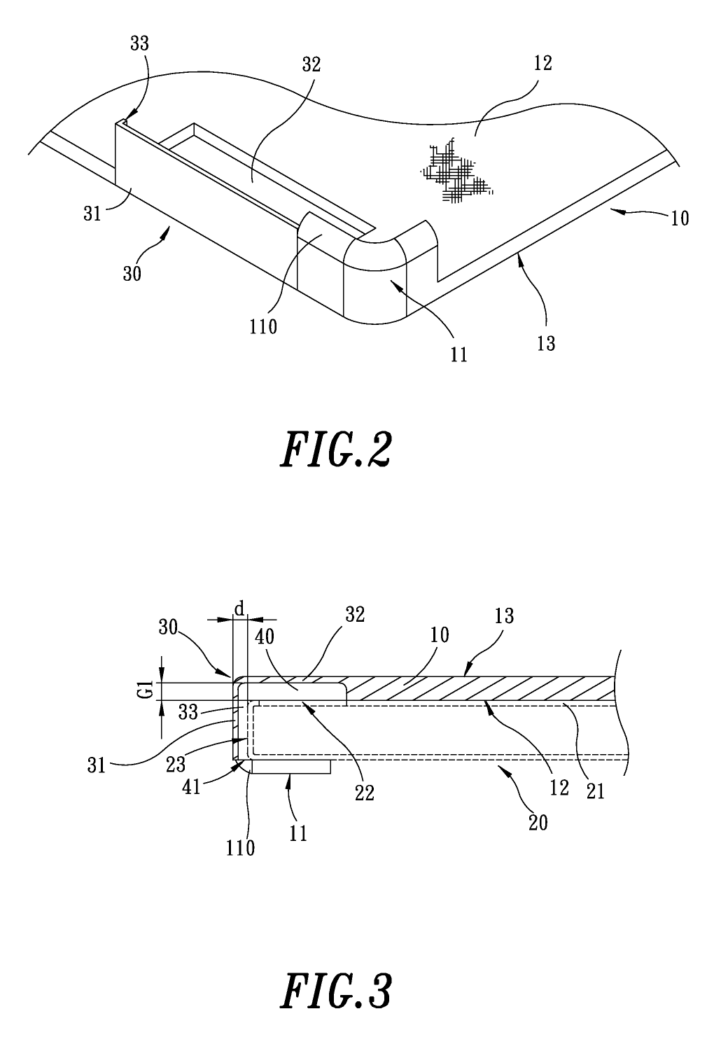

In one embodiment, the sound guide member 30 and the shield 10 are developed to be a one-piece structure (FIG. 2) wherein the shield 10 has a first surface 12 which faces the rear cover 21 of the electronic tablet device 20 and has an indentation corresponding to the speaker 22 and allowing its bottom to become the second reflector 32 of the sound guide member 30. The first reflector 31 which erects at an edge of the second reflector 32 parallels a side cover 23 of the electronic tablet device 20 in general. The sound guide channel 40 is enclosed by the first reflector 31, the second reflector 32 and the side wall 33 on the sound guide member 30 and the rear cover 21 and the side cover 23 on the electronic tablet device 20 because the fastener device 11 as one obstructer makes a small distance d reserved between edges of the side cover 23 and the shield 10 of the electronic tablet device 20 (FIG. 3) which has been installed on the shield 10. For the speaker 22 of the electronic tablet device 20 at the side cover 23 (FIG. 4), audio or sound from the speaker 22 can be guided to a user by means of reflection at the first reflector 31 and the second reflector 32.

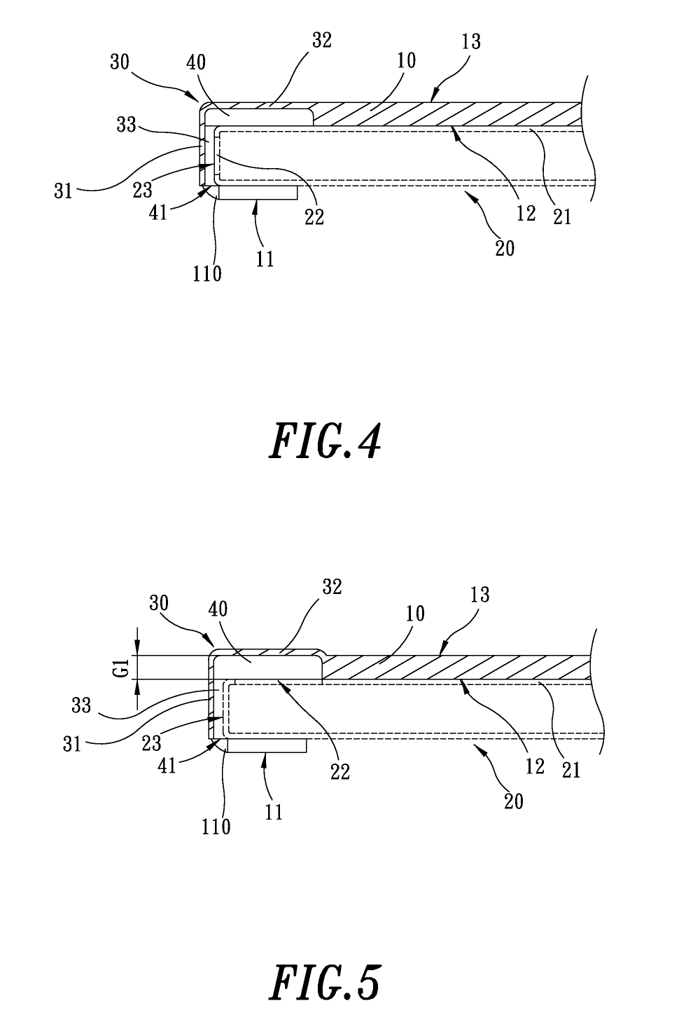

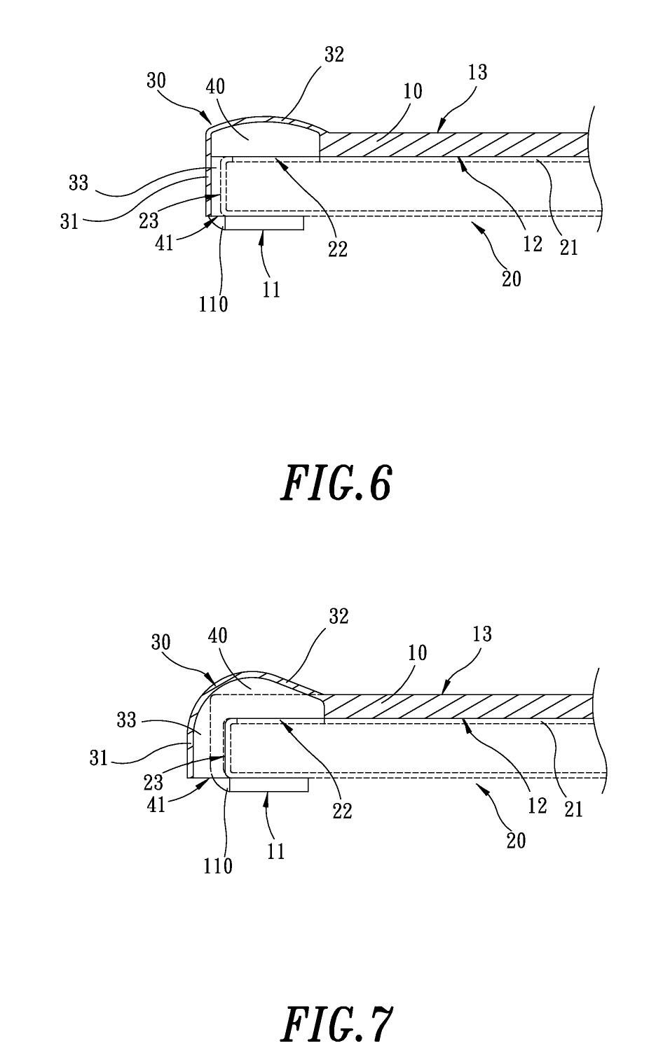

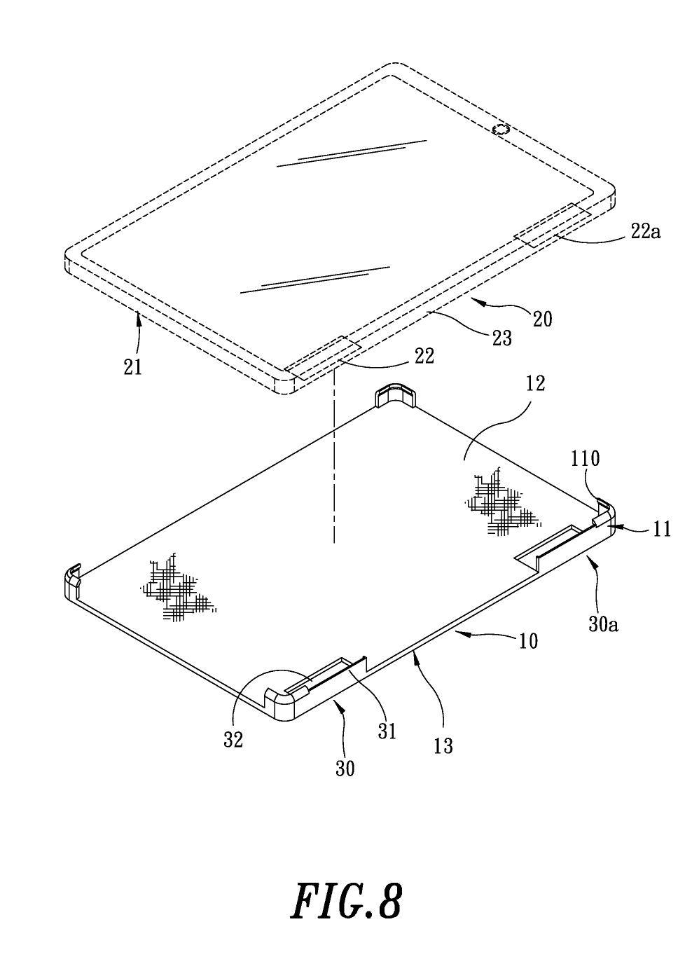

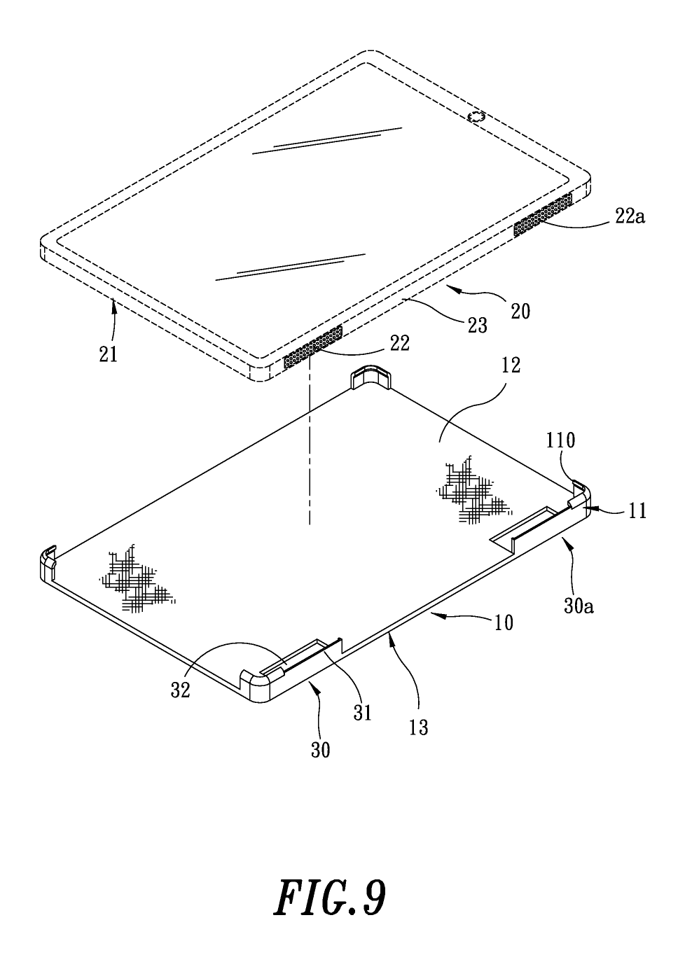

In one embodiment (FIG. 3), the second reflector 32 is a straight tubular member and levels with a second surface 13 (which is opposite to the first surface 12) of the shield 10. In another embodiment (FIG. 5), the second reflector 32 is still a straight tubular member but rises from the second surface 13 of the shield 10 in order to form a larger gap G2 between the second reflector 32 and the speaker 22 and effectively promote reflection as well as resonance of sound.

In a further embodiment (FIG. 6), the second reflector 32 is a tubular member with a curved cross-section wherein a curved opening faces the speaker 22. In yet another embodiment (FIG. 7), the sound guide member 30 is provided with the first reflector 31 and the second reflector 32 linking each other and has a cross-section similar to a parabola or an ellipse and the sound outlet 41 of the sound guide channel 40 is larger than that of the abovementioned sound guide member 30 in FIG. 3.

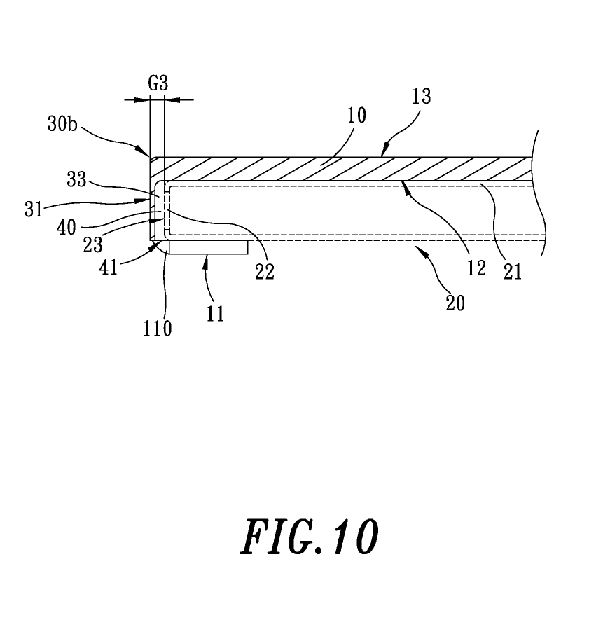

In another embodiment for the present invention of an electronic tablet device's sound guide cover, the electronic tablet device 20 has the rear cover 21 with two speakers 22, 22a and the shield 10 has two sound guide members 30, 30a which correspond to the speakers 22, 22a, respectively; similarly, the two sound guide members 30, 30a also guide audio or sound out of the speakers 22, 22a, which are located at the side cover 23 of the electronic tablet device 20 (FIG. 9), to a user.

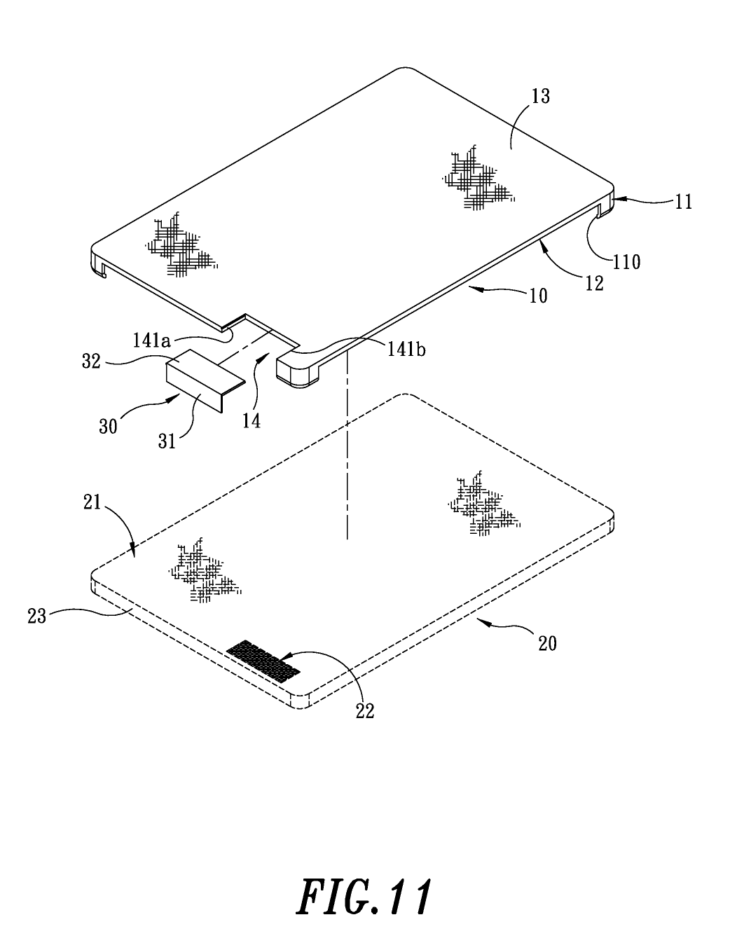

In a further embodiment for the present invention of an electronic tablet device's sound guide cover (FIG. 10), the sound guide member 30b is used to guide sound from the speaker 22 which is located at the side cover 23 of the electronic tablet device 20 to a user and provided with the first reflector 31 which is positioned at one edge of the shield 10, corresponds to the speaker 22, and extends in the direction paralleling the side cover 23. Due to a gap G3 between the first reflector 31 and the speaker 22, the first reflector 31 joins the side cover 23 of the electronic tablet device 20 to form the sound guide channel 40 and reflects sound out of the speaker 22 to the sound outlet 41 and finally a user.

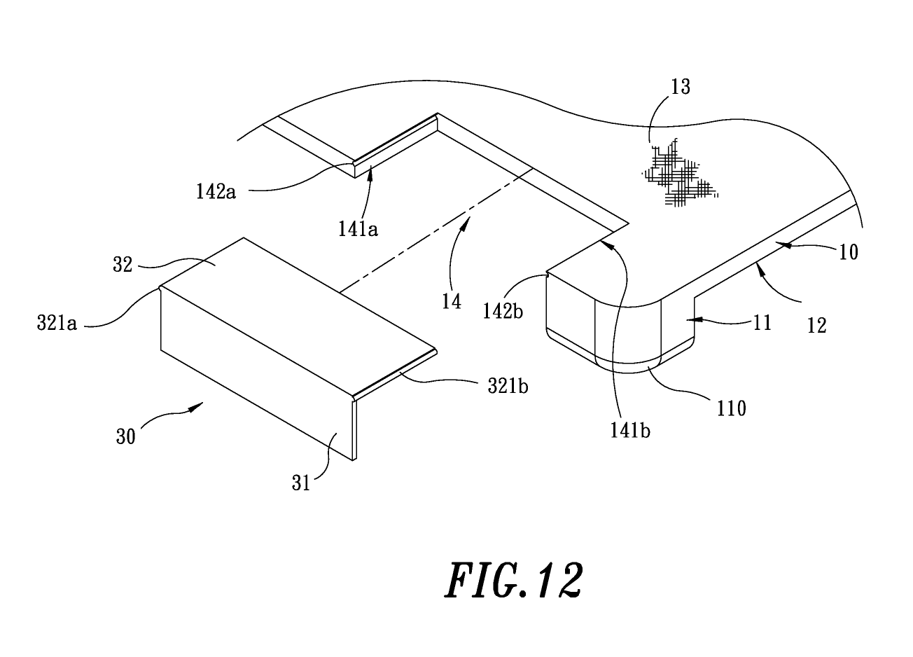

In yet a further embodiment (FIGS. 11 and 12), the sound guide member 30 is assembled to or separated from the shield 10. As shown in FIGS. 11 and 12, the shield 10 is provided with a notch 14 corresponding to the speaker 22 of the electronic tablet device 20 and including two opposite side walls 141a, 141b on which there are grooves 142a, 142b, respectively. On the sound guide member 30, ribs 321a, 321b located at two opposite flanks of the second reflector 32 can exactly slip into the grooves 142a, 142b so that the sound guide member 30 is unlimitedly assembled to or separated from the shield 10 by a user according to requirements.

Notwithstanding the foregoing, the embodiments disclosed for the present invention do not limit the present invention and any person skilled in the art may change or modify them without departing from the spirit and scope of the present invention. Therefore, the scope to be protected under the patent should refer to claims of the patent specifications.

What is claimed is:

1. An electronic tablet device's sound guide cover, comprising:
A shield used in positioning and wrapping said electronic tablet device;
A sound guide member disposed at said shield and corresponding to a speaker of said electronic tablet device wherein (a) said sound guide member and said corresponding speaker form a gap in between; (b) said sound guide member and an external cover of said electronic tablet device form a sound guide channel in between; (c) said sound guide channel has a sound outlet facing said electronic tablet device's front in order to guide audio or sound out of said electronic tablet device to an electronic tablet device's screen.

2. The electronic tablet device's sound guide cover according to claim 1 wherein said shield is provided with some fastener devices at corners, each of which has a hook part at the top slightly bending toward said shield's center and clasps said electronic tablet device's edge when said electronic tablet device is placed on said shield.

3. The electronic tablet device's sound guide cover according to claim 1 wherein said sound guide member guides sound out of said speaker which is located at said electronic tablet device's rear cover to an electronic tablet device's screen and is provided with a first reflector, a second reflector and a side wall: said second reflector corresponds to said speaker; said second reflector and said speaker form a gap in between; said second reflector reflects sound out of said speaker to said first reflector; said first reflector reflects sound to a user.

4. The electronic tablet device's sound guide cover according to claim 3 wherein said second reflector and said shield are developed to be a one-piece structure;
said shield is provided with a first surface which faces said electronic tablet device's rear cover and has an indentation corresponding to said speaker and allowing its bottom to become said second reflector; said first reflector erects on said second reflector's edge and substantially parallels said electronic tablet device's side cover; said sound guide channel is enclosed by said first reflector, said second reflector, said side wall, and said electronic tablet device's rear cover and side cover.

5. The electronic tablet device's sound guide cover according to claim 4 wherein said second reflector is a straight tabular member and levels with said shield's second surface which is opposite to said first surface.

6. The electronic tablet device's sound guide cover according to claim 5 wherein said second reflector rises from said second surface in order to form a larger gap between said second reflector and said speaker.

7. The electronic tablet device's sound guide cover according to claim 3 wherein said second reflector is a tubular member with a curved cross-section and a curved opening facing said speaker.

8. The electronic tablet device's sound guide cover according to claim 3 wherein said first reflector and said second reflector link each other and have a cross-section similar to either a parabola or an ellipse.

9. The electronic tablet device's sound guide cover according to claim 1 wherein said shield has a notch which corresponds to said electronic tablet device's speaker and includes two opposite side walls with grooves and said sound guide member is provided with said second reflector on which there are ribs installed on its two opposite sides and exactly slipping into said grooves so that said sound guide member is unlimitedly assembled to or separated from said shield.
